(19) United States
(12) Patent Application Publication
(10) Pub. No.: US 2026/0022674 A1
(43) Pub. Date: Jan. 22, 2026

(54) CONTROL DEVICE FOR INTERNAL COMBUSTION ENGINE

(71) Applicant: TOYOTA JIDOSHA KABUSHIKI KAISHA, Toyota-shi (JP)

(72) Inventor: Koji IDE, Gotemba-shi (JP)

(73) Assignee: TOYOTA JIDOSHA KABUSHIKI KAISHA, Toyota-shi (JP)

(21) Appl. No.: 19/059,758

(22) Filed: Feb. 21, 2025

(30) Foreign Application Priority Data
Jul. 22, 2024 (JP) 2024-116915

(51) Int. Cl. F02D 41/14; F02D 41/00; F02D 41/24

(52) U.S. Cl. CPC F02D 41/1473; F02D 41/1454; F02D 41/2454; F02D 41/0027

(57) ABSTRACT

An internal combustion engine includes a three-way catalyst provided in an exhaust path, an upstream-side air-fuel ratio sensor provided on the exhaust upstream side of the three-way catalyst, and a downstream-side air-fuel ratio sensor provided on the exhaust downstream side of the three-way catalyst. The CPU executes a correction process of making a correction of addressing an output deviation of the upstream-side air-fuel ratio sensor based on an output of the upstream-side air-fuel ratio sensor and an output of the downstream-side air-fuel ratio sensor in a case where the output of the downstream-side air-fuel ratio sensor indicates a value near the stoichiometric air-fuel ratio during the execution of air-fuel ratio control of controlling the air-fuel ratio of an air-fuel mixture based on the output of the upstream-side air-fuel ratio sensor such that the air-fuel ratio of the air-fuel mixture is an air-fuel ratio near the stoichiometric air-fuel ratio.

### CROSS-REFERENCE TO RELATED APPLICATION

This application claims priority to Japanese Patent Application No. 2024-116915 filed on Jul. 22, 2024, incorporated herein by reference in its entirety.

### BACKGROUND

### 1. Technical Field

The present disclosure relates to a control device for an internal combustion engine.

### 2. Description of Related Art

There is provided a three-way catalyst in an exhaust path of an internal combustion engine. There is provided an upstream-side air-fuel ratio sensor on the exhaust upstream side of the three-way catalyst and there is provided a downstream-side air-fuel ratio sensor on the exhaust downstream side of the three-way catalyst. A control device for the internal combustion engine then executes air-fuel ratio control of controlling the air-fuel ratio of an air-fuel mixture based on an output of the upstream-side air-fuel ratio sensor such that the air-fuel ratio of the air-fuel mixture is an air-fuel ratio near the stoichiometric air-fuel ratio.

Exhaust gas including hydrogen causes an output deviation in which an output of the upstream-side air-fuel ratio sensor has a value that is richer than the actual air-fuel ratio. Accordingly, technology described in Japanese Unexamined Patent Application Publication No. 2013-185512 (JP 2013-185512 A) controls the upstream exhaust air-fuel ratio of the three-way catalyst such that the upstream exhaust air-fuel ratio of the three-way catalyst is a rich air-fuel ratio that is richer than the stoichiometric air-fuel ratio. Depending on the difference between an output of the upstream-side air-fuel ratio sensor and an output of the downstream-side air-fuel ratio sensor detected a reference time after the upstream exhaust air-fuel ratio is a rich air-fuel ratio, the output of the upstream-side air-fuel ratio sensor is then corrected.

### SUMMARY

It is, however, difficult to advance an oxidation reaction of hydrogen by the three-way catalyst under a rich atmosphere. Therefore, the downstream-side air-fuel ratio sensor also has an output deviation due to hydrogen. Accordingly, it is difficult for the technology described in JP 2013-185512 A to accurately make a correction of addressing the output deviation of the upstream-side air-fuel ratio sensor.

A control device for an internal combustion engine that solves the problem is applied to the internal combustion engine. The internal combustion engine includes a three-way catalyst provided in an exhaust path, an upstream-side air-fuel ratio sensor provided on the exhaust upstream side of the three-way catalyst, and a downstream-side air-fuel ratio sensor provided on the exhaust downstream side of the three-way catalyst. The control device executes a correction process of making a correction of addressing an output deviation of the upstream-side air-fuel ratio sensor based on an output of the upstream-side air-fuel ratio sensor and an output of the downstream-side air-fuel ratio sensor in a case where the output of the downstream-side air-fuel ratio sensor indicates a value near the stoichiometric air-fuel ratio during the execution of air-fuel ratio control of controlling the air-fuel ratio of an air-fuel mixture based on the output of the upstream-side air-fuel ratio sensor such that the air-fuel ratio of the air-fuel mixture is an air-fuel ratio near the stoichiometric air-fuel ratio.

The disclosure makes it possible to accurately make a correction of addressing an output deviation of an upstream-side air-fuel ratio sensor.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram illustrating configurations of an internal combustion engine and a control device according to an embodiment;

FIG. 2 is a block diagram illustrating a process that is executed by the control device according to the embodiment;

FIG. 3 is a flowchart illustrating a procedure of a process that is executed by the control device according to the embodiment; and

FIG. 4 is a block diagram illustrating a process that is executed by a control device in a modification example of the embodiment.

### DETAILED DESCRIPTION OF EMBODIMENTS

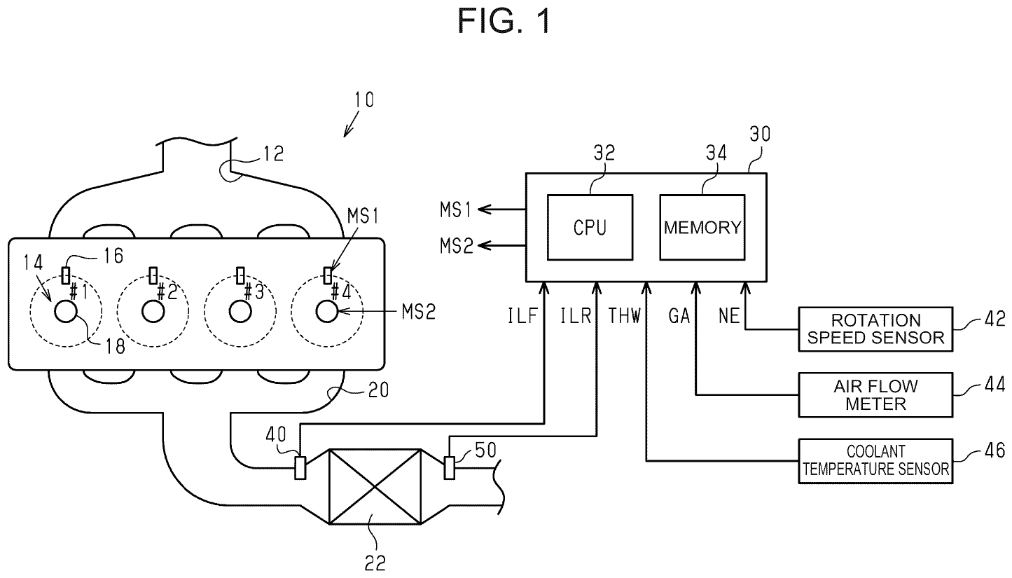

Hereinafter, an embodiment of a control device for an internal combustion engine will be described with reference to FIG. 1 to FIG. 3.

### Regarding Configuration of Internal Combustion Engine

As illustrated in FIG. 1, an internal combustion engine 10 includes the four cylinders of a first cylinder #1, a second cylinder #2, a third cylinder #3, and a fourth cylinder #4 arranged in series. Additionally, it is possible to change as appropriate the number of cylinders included in the internal combustion engine 10 and the arrangement of the cylinders. In addition, the internal combustion engine 10 is supposed to be mounted on a vehicle.

Air in an intake path 12 of the internal combustion engine 10 is taken in to respective combustion chambers 14 of the first cylinder #1 to the fourth cylinder #4.

A fuel injection valve 16 protrudes in each of the combustion chambers 14. An air-fuel mixture of fuel injected from the fuel injection valve 16 and air taken in to the combustion chamber 14 from the intake path 12 is burned through ignition by spark discharge of an ignition plug 18.

The burned air-fuel mixture is discharged to an exhaust path 20 as exhaust gas. The exhaust path 20 is provided with a three-way catalyst 22 that purifies the exhaust gas. The exhaust upstream side of the three-way catalyst 22 is provided with an upstream-side air-fuel ratio sensor 40. The exhaust downstream side of the three-way catalyst 22 is provided with a downstream-side air-fuel ratio sensor 50.

The upstream-side air-fuel ratio sensor 40 and the downstream-side air-fuel ratio sensor 50 are well-known limiting current type oxygen sensors. The limiting current type oxygen sensors are sensors each including a ceramic layer called a diffusion-controlled layer in a detection section of a concentration cell type oxygen sensor, thereby obtaining an output current serving as an output value corresponding to the oxygen concentration of exhaust gas. The limiting current type oxygen sensor has an output current of “0” in a case where an air-fuel ratio having a close relationship with the oxygen concentration of the exhaust gas is the stoichiometric air-fuel ratio. In addition, as the air-fuel ratio grows richer, the output current grows more in the negative direction. As the air-fuel ratio grows leaner, the output current grows more in the positive direction.

A control device 30 includes a CPU 32, a memory 34, and the like. The CPU 32 executes a program stored in the memory 34 to carry out various kinds of control over the internal combustion engine 10.

To execute the various kinds of control over the internal combustion engine 10, the control device 30 operates various actuators such as the fuel injection valve 16 and the ignition plug 18.

To perform the various kinds of control, the control device 30 refers to an upstream-side output value ILF that is an output value of the upstream-side air-fuel ratio sensor 40 and a downstream-side output value ILR that is an output value of the downstream-side air-fuel ratio sensor 50. In addition, to perform the various kinds of control, the control device 30 also refers to engine speed NE detected by a rotation speed sensor 42, an intake air amount GA detected by an air flow meter 44, coolant temperature THW detected by a coolant temperature sensor 46, and the like. The control device 30 calculates an engine load factor KL based on the engine speed NE, the intake air amount GA, and the like.

In addition, in the present embodiment, an excess air ratio λ is used as a value indicating an air-fuel ratio. The control device 30 therefore applies map conversion to the upstream-side output value ILF to calculate an upstream-side excess air ratio λF and applies map conversion to the downstream-side output value ILR to calculate a downstream-side excess air ratio λR.

### Regarding Air-Fuel Ratio Control

To appropriately purify exhaust gas by the three-way catalyst 22, the control device 30 executes well-known air-fuel ratio control. The air-fuel ratio control includes main air-fuel ratio control of controlling the air-fuel ratio of an air-fuel mixture based on an output of the upstream-side air-fuel ratio sensor 40 such that the air-fuel ratio of the air-fuel mixture is a target air-fuel ratio, and sub-air-fuel ratio control of correcting a value related to the main air-fuel ratio control by using a sub-correction value calculated based on an output of the downstream-side air-fuel ratio sensor 50. It is to be noted that the target air-fuel ratio in the main air-fuel ratio control and the sub-air-fuel ratio control is basically the stoichiometric air-fuel ratio in the present embodiment. The target value of the excess air ratio λ in the main air-fuel ratio control and the sub-air-fuel ratio control is thus “λ=1.0” basically.

The main air-fuel ratio control is basically control as follows. The control device 30 respectively calculates a proportional term, and an integral term and a differential term each serving as a learning value from the deviation between a target excess air ratio λFt that is the target value of the air-fuel ratio of an air-fuel mixture and the upstream-side excess air ratio λF, and a proportional gain, an integral gain, and a differential gain experimentally obtained in advance. PID control of calculating a correction value for the currently set fuel injection control amount of the fuel injection valve 16 from the sum of the proportional term, the integral term, and the differential term is then carried out. It is to be noted that feedback control such as PI control of calculating the correction value based on the proportional term and the integral term may be carried out instead of the PID control.

The control device 30 then corrects the fuel injection control amount by using the calculated correction value. For example, in a case where the upstream-side excess air ratio λF is higher than the target excess air ratio λFt and the exhaust air-fuel ratio is lean, the fuel injection control amount is corrected to increase. In contrast, in a case where the upstream-side excess air ratio λF is lower than the target excess air ratio λFt and the exhaust air-fuel ratio is rich, the fuel injection control amount is corrected to decrease. The upstream-side excess air ratio λF is controlled to approach the target excess air ratio λFt through such feedback control over the air-fuel ratio, thereby controlling the air-fuel ratio of the air-fuel mixture such that the air-fuel ratio of the air-fuel mixture is an air-fuel ratio near the stoichiometric air-fuel ratio.

The sub-air-fuel ratio control is basically control as follows. The control device 30 calculates a sub-FB value SFB serving as a proportional term and a sub-learning value SFBG including an integral term and a differential term each serving as a learning value from the deviation between a sub-target excess air ratio λRt and the downstream-side excess air ratio λR, and a proportional gain, an integral gain, and a differential gain obtained in advance. PID control of calculating a sub-correction value that is a correction value for the currently set target excess air ratio λFt from the sum of the proportional term, the integral term, and the differential term is then carried out. It is to be noted that feedback control such as PI control of calculating the sub-correction value based on the proportional term and the integral term may be carried out instead of the PID control.

The control device 30 then corrects the target excess air ratio λFt by using the calculated sub-correction value. For example, in a case where the downstream-side excess air ratio λR is higher than the sub-target excess air ratio λRt and the exhaust air-fuel ratio is lean, the target excess air ratio λFt is corrected to change into a value on the rich side. In contrast, in a case where the downstream-side excess air ratio λR is lower than the sub-target excess air ratio λRt and the exhaust air-fuel ratio is rich, the target excess air ratio λFt is corrected to change into a value on the lean side. The main air-fuel ratio control is executed based on the target excess air ratio λFt that has been thus corrected by using the sub-correction value. It is to be noted that the target excess air ratio λFt is a value that is corrected by using a sub-correction value calculated based on an output of the downstream-side air-fuel ratio sensor 50 and is related to air-fuel ratio control.

### Regarding Correction of Addressing Output Deviation of Upstream-Side Air-Fuel Ratio Sensor

Exhaust gas including hydrogen causes an output deviation in which an output of the upstream-side air-fuel ratio sensor 40 has a value that is richer than the actual air-fuel ratio. Such an output deviation may shift the air-fuel ratio of an air-fuel mixture adjusted under air-fuel ratio control to the lean side and influence the purification performance of the three-way catalyst 22. Accordingly, the present embodiment prepares in advance a hydrogen estimation map that estimates hydrogen concentration H2C of exhaust gas based on an engine driven state. The upstream-side excess air ratio λF is then obtained based on the hydrogen concentration H2C calculated based on the hydrogen estimation map and the upstream-side output value ILF.

Here, the hydrogen concentration H2C obtained from the hydrogen estimation map may have an error because of a change in the internal combustion engine 10 over years, an individual difference of the internal combustion engine 10, or the like. In the case of such an error, it is not therefore possible to sufficiently restrain an output deviation of the upstream-side air-fuel ratio sensor 40 due to hydrogen included in exhaust gas.

Here, when the air-fuel ratio of an air-fuel mixture is controlled such that the air-fuel ratio of the air-fuel mixture is an air-fuel ratio near the stoichiometric air-fuel ratio, hydrogen is purified through the three-way catalyst 22 even if exhaust gas includes any hydrogen. An output of the downstream-side air-fuel ratio sensor 50 is therefore influenced by the hydrogen less easily. It is thus possible to estimate as follows in a case where an output of the downstream-side air-fuel ratio sensor 50 indicates a value near the stoichiometric air-fuel ratio during the execution of air-fuel ratio control of controlling the air-fuel ratio of the air-fuel mixture such that the air-fuel ratio of the air-fuel mixture is an air-fuel ratio near the stoichiometric air-fuel ratio. That is, it is possible to estimate that the hydrogen included in the exhaust gas is purified by the three-way catalyst 22 and an output of the downstream-side air-fuel ratio sensor 50 is not influenced by the hydrogen.

Accordingly, in a case where the condition is satisfied and it is possible to estimate that an output of the downstream-side air-fuel ratio sensor 50 is not influenced by hydrogen, the control device 30 according to the present embodiment executes a process of correcting an output of the upstream-side air-fuel ratio sensor 40 based on the output of the downstream-side air-fuel ratio sensor 50.

Hereinafter, a correction of addressing an output deviation of the upstream-side air-fuel ratio sensor 40 made by the control device 30 according to the present embodiment will be described.

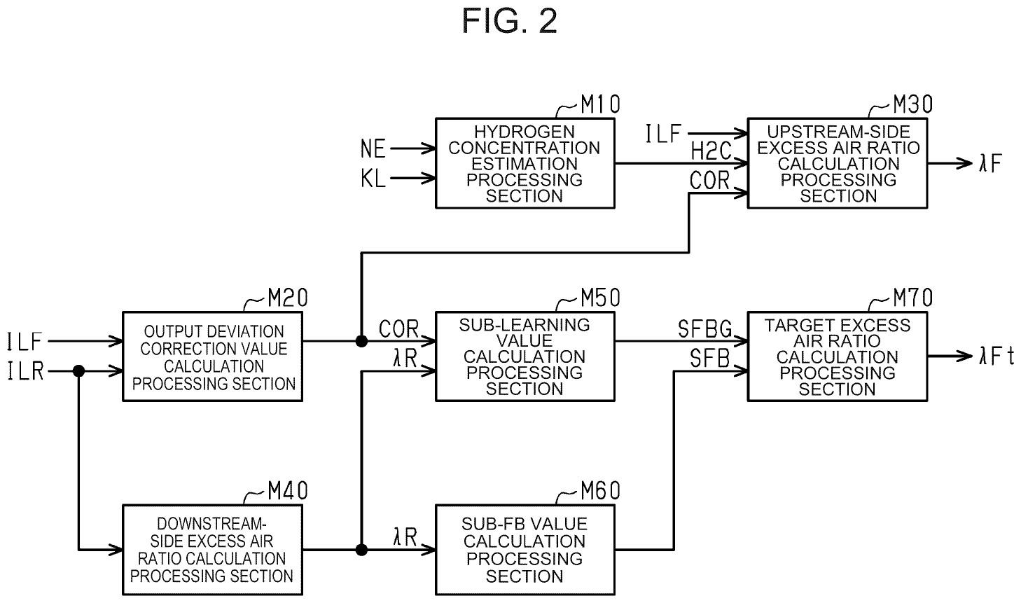

FIG. 2 illustrates a process achieved by the CPU 32 executing a program stored in the memory 34.

A hydrogen concentration estimation processing section M10 calculates the hydrogen concentration H2C based on the engine speed NE and the engine load factor KL with reference to the hydrogen estimation map described above.

An output deviation correction value calculation processing section M20 calculates an output deviation correction value COR. The output deviation correction value COR is a value that is multiplied by a base excess ratio λFb when the upstream-side excess air ratio λF is calculated.

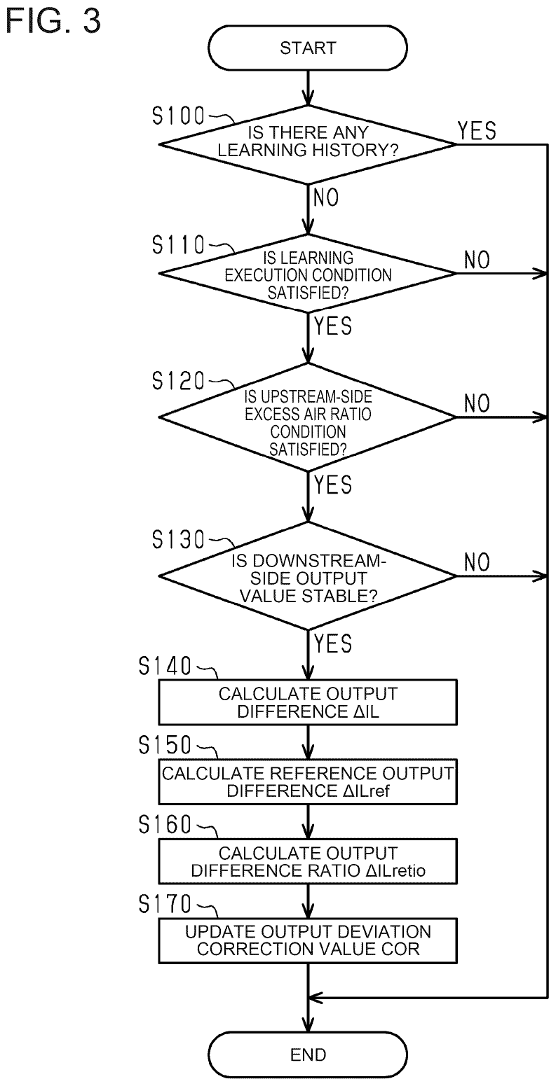

FIG. 3 illustrates procedures of processes that are executed by the output deviation correction value calculation processing section M20. It is to be noted that the present processes are achieved by the CPU 32 repeatedly executing a program stored in the memory 34 in each predetermined cycle while the engine is being driven. In addition, a step number will be expressed below by a numeral having “S” attached to the head thereof.

In the series of processes illustrated in FIG. 3, the CPU 32 determines whether or not there is a learning history of the output deviation correction value COR in the current trip (S100). The trip is the period from an on operation on the ignition switch of a vehicle on which the internal combustion engine 10 is mounted to an off operation. In addition, in a case where the process of S170 described below has been already executed in the current trip, the CPU 32 determines that there is a learning history of the output deviation correction value COR.

In a case where it is determined that there is no learning history (S100: NO), the CPU 32 determines whether or not a learning execution condition of the output deviation correction value COR is satisfied (S110). For example, in a case where the following condition (a) to condition (d) are all satisfied in the process of S110, the CPU 32 determines that the learning execution condition is satisfied.
(a): The internal combustion engine 10 has been completely warmed up.
(b): The engine speed NE is a value within a predefined range.
(c): The engine load factor KL is a value within a predefined range.
(d): A predefined time has passed after sub-air-fuel ratio control is started.

In a case where it is determined that the learning execution condition is satisfied in the process of S110 (S100: YES), the CPU 32 determines whether or not an upstream-side excess air ratio condition is satisfied (S120). For example, in a case where the following condition (e) is satisfied in the process of S120, the CPU 32 determines that the upstream-side excess air ratio condition is satisfied.
(e): Air-fuel ratio control of controlling the air-fuel ratio of an air-fuel mixture such that the air-fuel ratio of the air-fuel mixture is an air-fuel ratio near the stoichiometric air-fuel ratio is executed. More specifically, in a case where the average value of the upstream-side excess air ratios λF calculated in a predefined period is a value within a predefined range around the excess air ratio λ=1, the CPU 32 determines that the condition (e) is satisfied.

In a case where it is determined that the upstream-side excess air ratio condition is satisfied in the process of S120 (S120: YES), the CPU 32 determines whether or not the downstream-side output value ILR is stable (S130).

For example, in a case where the following condition (f) is satisfied in the process of S130, the CPU 32 determines that the downstream-side output value ILR is stable.
(f): A state in which the downstream-side output value ILR is a value within a predefined range continues for a predefined time or more. It is to be noted that being within the predefined range is synonymous with an output of the downstream-side air-fuel ratio sensor 50 indicating a value near the stoichiometric air-fuel ratio. For example, being within the predefined range is a state in which an output current of the downstream-side air-fuel ratio sensor 50 is within a predefined range around “0”.

In a case where it is determined that the downstream-side output value ILR is stable in the process of S130 (S130: YES), the CPU 32 calculates an output difference ΔIL based on the following Expression (1) (S140).

$$Δ IL = ILRAV - ILFAV \qquad ( 1 )$$

ILRAV: The average value of the downstream-side excess air ratios AR in a predefined period
ILFAV: The average value of the upstream-side excess air ratios λF in a predefined period

As exhaust gas has a higher hydrogen concentration, the upstream-side output value ILF deviates more to the rich side. As the value of the output difference AIL, the upstream-side output value ILF therefore has a larger absolute value in the negative direction. Thus, as the upstream-side output value ILF deviates more to the rich side, the output difference ΔIL has a larger value in the positive direction.

Next, the CPU 32 calculates a reference output difference ΔILref (S150). The reference output difference ΔILref is the output difference ΔIL calculated when the respective conditions (a) to (f) are all satisfied in a reference internal combustion engine used to obtain test data for fabricating the hydrogen estimation map described above. The memory 34 stores map data in which the correspondence relationship between the engine speed NE and the engine load factor KL for calculating the reference output difference ΔILref and the reference output difference ΔILref is described. In the process of S150, the CPU 32 calculates the reference output difference ΔILref based on the engine speed NE and the engine load factor KL with reference to the map data.

Next, the CPU 32 calculates an output difference ratio ΔILretio based on the following Expression (2) (S160).

$$Δ ILretio = Δ IL / Δ ILref \qquad ( 2 )$$

ΔIL: An output difference calculated in the process of S140
ΔILref: A reference output difference calculated in the process of S150

As described above, as the upstream-side output value ILF deviates more to the rich side, the value of the output difference ΔIL grows larger in the positive direction. Thus, as the upstream-side output value ILF deviates more to the rich side, the output difference ratio ΔILretio has a larger value in the positive direction.

Next, the CPU 32 updates the output deviation correction value COR based on the following Expression (3) (S170).

$$COR = CORpre + \{ ( Δ ILretio - CORpre ) / 2 \} \qquad ( 3 )$$

CORpre: An output deviation correction value previously calculated in the process of S170
ΔILretio: An output difference ratio calculated in the process of S160

As shown in Expression (3), the output deviation correction value COR is a smoothing value of the output difference ratio ΔILretio.

In a case where the process of S170 comes to an end, in a case where an affirmative determination is made in the process of S100, or in a case where a negative determination is made in any of the respective processes of S110, S120, and S130, the CPU 32 temporarily ends the present process.

An upstream-side excess air ratio calculation processing section M30 illustrated in FIG. 2 calculates the base excess ratio λFb based on the upstream-side output value ILF and the hydrogen concentration H2C calculated by the hydrogen concentration estimation processing section M10 with reference to a conversion map set in advance. The upstream-side excess air ratio calculation processing section M30 then calculates the value obtained by multiplying the base excess ratio λFb by the output deviation correction value COR calculated by the output deviation correction value calculation processing section M20. The upstream-side excess air ratio calculation processing section M30 then assigns the calculated value to the upstream-side excess air ratio λF.

A sub-learning value calculation processing section M50 calculates the sub-learning value SFBG through the sub-air-fuel ratio control described above. In addition, in a case where the output deviation correction value calculation processing section M20 updates the output deviation correction value COR, the sub-learning value calculation processing section M50 executes a modification process of modifying the sub-learning value SFBG. If described in more detail, the sub-learning value calculation processing section M50 modifies the sub-learning value SFBG based on the following Expression (4).

$$SFBG = SFBGpre - ( COR / CORpre - 1 ) \qquad ( 4 )$$

SFBGpre: A sub-learning value that has not yet been modified
COR: An updated output deviation correction value
CORpre: An output deviation correction value that has not yet been updated

A sub-FB value calculation processing section M60 calculates the sub-FB value SFB through the sub-air-fuel ratio control described above.

A target excess air ratio calculation processing section M70 calculates the target excess air ratio λFt based on the following Expression (5).

$$λ Ft = λ Ftb \times \{ 1 / ( 1 + SFB + SFBG ) \} \qquad ( 5 )$$

λFtb: A target excess air ratio base value
SFB: A sub-FB value
SFBG: A sub-learning value

In the present embodiment, the target excess air ratio base value λFtb is set to “1”, but the variable target excess air ratio base value λFtb may be set based on the engine driven state.

### Workings and Effects of Present Embodiment

(1) In the present embodiment, the correction process described above is executed in a case where an output of the downstream-side air-fuel ratio sensor 50 indicates a value near the stoichiometric air-fuel ratio during the execution of air-fuel ratio control of controlling the air-fuel ratio of an air-fuel mixture based on an output of the upstream-side air-fuel ratio sensor 40 such that the air-fuel ratio of the air-fuel mixture is an air-fuel ratio near the stoichiometric air-fuel ratio. That is, a correction process of making a correction of addressing an output deviation of the upstream-side air-fuel ratio sensor based on the output of the upstream-side air-fuel ratio sensor 40 and the output of the downstream-side air-fuel ratio sensor 50 is executed. In the correction process, the base excess ratio λFb calculated based on an output value of the upstream-side air-fuel ratio sensor 40 is corrected with the output deviation correction value COR calculated based on the output of the upstream-side air-fuel ratio sensor 40 and the output of the downstream-side air-fuel ratio sensor 50. The correction of addressing the output deviation of the upstream-side air-fuel ratio sensor 40 is made in such a way by using the output of the downstream-side air-fuel ratio sensor 50 that is influenced by hydrogen less easily. It is thus possible to accurately make the correction of addressing the output deviation of the upstream-side air-fuel ratio sensor 40.
(2) The magnitude of an output deviation of the upstream-side air-fuel ratio sensor 40 is reflected in the difference between an output of the upstream-side air-fuel ratio sensor 40 and an output of the downstream-side air-fuel ratio sensor 50.

Accordingly, the CPU 32 calculates the output difference ΔIL that is the difference between the output of the upstream-side air-fuel ratio sensor 40 and the output of the downstream-side air-fuel ratio sensor 50 as the correction process described above. The CPU 32 then makes the correction by using the output deviation correction value COR calculated by using the output difference ΔIL. It is thus possible to appropriately make the correction of addressing the output deviation of the upstream-side air-fuel ratio sensor 40 depending on the magnitude of the output deviation.
(3) In a case where an output of the downstream-side air-fuel ratio sensor 50 indicates a value near the stoichiometric air-fuel ratio though the upstream-side air-fuel ratio sensor 40 has an output deviation due to hydrogen in exhaust gas, the following state is entered. That is, a state in which an error of the whole air-fuel ratio control due to an output deviation of the upstream-side air-fuel ratio sensor 40 is absorbed by a sub-correction value calculated under the sub-air-fuel ratio control is entered. Thus, in a case where a correction of addressing the output deviation of the upstream-side air-fuel ratio sensor 40 is made, the sub-correction value may be an excessively large value without any modification for the sub-correction value.

Accordingly, in a case where sub-air-fuel ratio control of correcting a value related to air-fuel ratio control over the air-fuel mixture is carried out by using the sub-correction value calculated based on an output of the downstream-side air-fuel ratio sensor 50, the CPU 32 executes the following process. That is, in a case where the correction process of addressing the output deviation of the upstream-side air-fuel ratio sensor 40 is executed, a process of modifying the sub-learning value SFBG that is a sub-correction value based on Expression (4) is also executed. Thus, in a case where the correction of addressing the output deviation of the upstream-side air-fuel ratio sensor 40 is made, it is possible to set the sub-learning value SFBG that is one of sub-correction values to an appropriate value.
(4) Unburned hydrogen increases the hydrogen concentration of exhaust gas in the internal combustion engine 10 that uses hydrogen as fuel. The upstream-side air-fuel ratio sensor 40 therefore has an output deviation due to the hydrogen in the exhaust gas easily. In the respect, the correction process described above is executed in the present embodiment and it is therefore possible to accurately make a correction of addressing the output deviation of the upstream-side air-fuel ratio sensor 40 even in the internal combustion engine 10 that uses hydrogen as fuel.

### Modification Examples

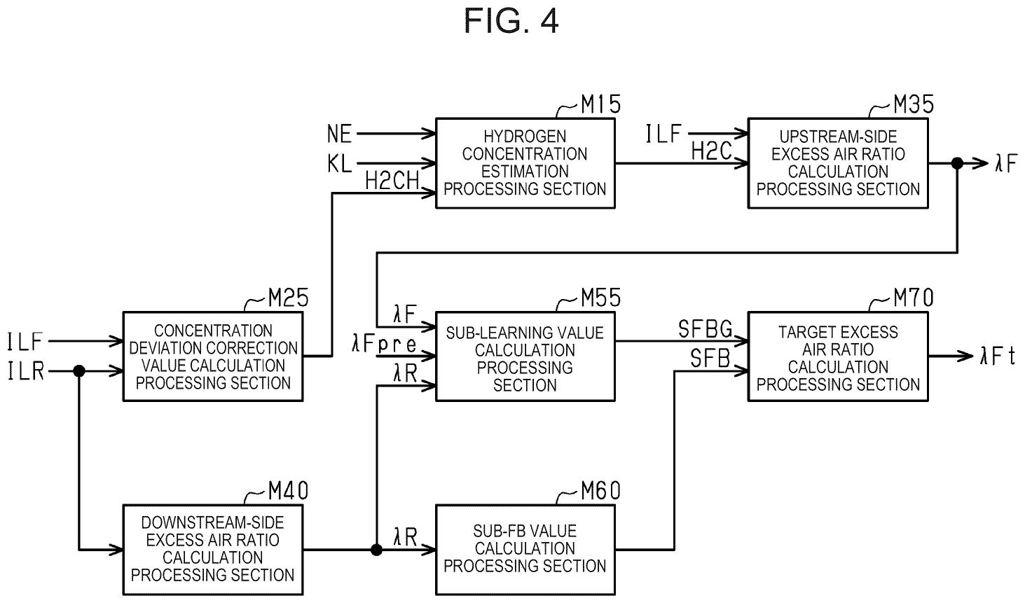

Additionally, it is also possible to modify and carry out the embodiment as follows.
To make a correction of addressing an output deviation of the upstream-side air-fuel ratio sensor 40, the base excess ratio λFb calculated based on the upstream-side output value ILF is corrected in the present embodiment, but another value may be corrected. For example, the CPU 32 may correct the upstream-side output value ILF by using the output deviation correction value COR. In addition, the CPU 32 may correct the injection quantity of the fuel injection valve 16 by using the output deviation correction value COR.
The hydrogen concentration estimation processing section M10 is omitted. The upstream-side excess air ratio calculation processing section M30 may then calculate the upstream-side excess air ratio λF based on the upstream-side output value ILF and the output deviation correction value COR.
The output deviation correction value COR may be updated a plurality of times in one trip.
The process of S170 illustrated in FIG. 3 is omitted. The output difference ratio ΔILretio calculated in the process of S160 may be then assigned to the output deviation correction value COR.
The output difference ratio ΔILretio is calculated, but the output difference ΔIL may be simply assigned to the output deviation correction value COR.
As illustrated in FIG. 4, a part of the block diagram illustrated in FIG. 2 may be modified and carried out. It is to be noted that the same processing section as a processing section illustrated in FIG. 2 is denoted by the same reference numeral in FIG. 4.

A hydrogen concentration estimation processing section M15 calculates a hydrogen concentration base value H2Cb based on the engine speed NE and the engine load factor KL with reference to the hydrogen estimation map described above. The value obtained by multiplying the hydrogen concentration base value H2Cb by a concentration deviation correction value H2CH described below is then assigned to the hydrogen concentration H2C.

A concentration deviation correction value calculation processing section M25 calculates the concentration deviation correction value H2CH. Here, as described above, as exhaust gas has a higher hydrogen concentration, the upstream-side output value ILF deviates more to the rich side. The upstream-side output value ILF therefore has a larger absolute value in the negative direction. Thus, as the upstream-side output value ILF deviates more to the rich side, the output difference ΔIL has a larger value in the positive direction. As the output difference ΔIL has a larger value in the positive direction, the output difference ratio ΔILretio has a larger value in the positive direction. The magnitude of the deviation of the estimation value of the hydrogen concentration obtained from the map and the actual hydrogen concentration is thus reflected in the output difference ratio ΔILretio. That is, as the output difference ratio ΔILretio grows higher, the actual hydrogen concentration deviates in the higher direction from the estimation value of the hydrogen concentration. Accordingly, the concentration deviation correction value calculation processing section M25 executes the series of processes illustrated in FIG. 3 and updates the concentration deviation correction value H2CH based on the following Expression (6) in the process of S170 instead of Expression (3).

$$H 2 CH = H 2 CHpre + \{ ( Δ ILretio - H 2 CHpre ) / 2 \} \qquad ( 6 )$$

H2CHpre: A concentration deviation correction value previously calculated in the process of S170
ΔILretio: An output difference ratio calculated in the process of S160

As shown in Expression (6), the concentration deviation correction value H2CH is a smoothing value of the output difference ratio ΔILretio.

An upstream-side excess air ratio calculation processing section M35 calculates the upstream-side excess air ratio λF based on the upstream-side output value ILF and the hydrogen concentration H2C calculated by the hydrogen concentration estimation processing section M15 with reference to a conversion map set in advance.

A sub-learning value calculation processing section M55 calculates the sub-learning value SFBG through the sub-air-fuel ratio control described above. In addition, in a case where the concentration deviation correction value calculation processing section M25 updates the concentration deviation correction value H2CH, the sub-learning value calculation processing section M55 executes a process of modifying the sub-learning value SFBG. If described in more detail, the sub-learning value calculation processing section M50 modifies the sub-learning value SFBG based on the following Expression (7).

$$SFBG = SFBGpre - ( λ F / λ Fpre - 1 ) \qquad ( 7 )$$

SFBGpre: A sub-learning value that has not yet been modified
λF: An upstream-side excess air ratio calculated after the concentration deviation correction value H2CH is updated
λFpre: An upstream-side excess air ratio calculated before the concentration deviation correction value H2CH is updated

It is to be noted that the value of “λFpre” is preserved in a memory in association with each of the individual upstream-side output values ILF before the concentration deviation correction value H2CH is updated. The sub-learning value calculation processing section M55 then obtains the value of “AF” and the value of “λFpre” for the same upstream-side output value ILF in a case where the sub-learning value SFBG is modified in accordance with Expression (7). A change in the calculated value of the upstream-side excess air ratio λF before and after the concentration deviation correction value H2CH is updated is thus reflected in the value of “λF/λFpre”. The sub-learning value SFBG is therefore modified appropriately in accordance with the update of the concentration deviation correction value H2CH. Such a modification example also then offers workings and effects similar to the workings and effects of the embodiment.
The sub-learning value SFBG is modified in a case where a correction process of addressing an output deviation of the upstream-side air-fuel ratio sensor 40 is executed, but the sub-FB value SFB may be modified.
A modification process of the sub-learning value SFBG may be omitted.
The fuel injection valve 16 is not limited to what injects fuel to the combustion chamber 14. For example, a fuel injection valve that injects fuel to an intake port of the internal combustion engine 10 may be adopted.
The internal combustion engine 10 may be an internal combustion engine that uses a material other than hydrogen as fuel.
The control device 30 is not limited to what includes a CPU and a memory, and executes a software process. For example, the control device 30 may include, for example, a dedicated hardware circuit such as an ASIC that applies a hardware process to at least part of what is subjected to a software process in the embodiment. That is, it is sufficient if the control device 30 includes a processing circuit including any of the components of (a) to (c) below. (a) A processing circuit including one or more processing devices that execute all the processes in accordance with a program and one or more program storage devices such as a ROM that store the program. (b) A processing circuit including one or more processing devices that execute some of the processes in accordance with a program, one or more program storage devices, and one or more dedicated hardware circuits that execute the rest of the processes. (c) A processing circuit including one or more dedicated hardware circuits that execute all the processes. The program storage devices or computer-readable media include any available media accessible to a general-purpose or dedicated computer.

What is claimed is:

1. A control device for an internal combustion engine including a three-way catalyst provided in an exhaust path, an upstream-side air-fuel ratio sensor provided on an exhaust upstream side of the three-way catalyst, and a downstream-side air-fuel ratio sensor provided on an exhaust downstream side of the three-way catalyst, the control device being configured to be applied to the internal combustion engine, wherein the control device is configured to execute a correction process of making a correction of addressing an output deviation of the upstream-side air-fuel ratio sensor based on an output of the upstream-side air-fuel ratio sensor and an output of the downstream-side air-fuel ratio sensor in a case where the output of the downstream-side air-fuel ratio sensor indicates a value near a stoichiometric air-fuel ratio during execution of air-fuel ratio control of controlling an air-fuel ratio of an air-fuel mixture based on the output of the upstream-side air-fuel ratio sensor such that the air-fuel ratio of the air-fuel mixture is an air-fuel ratio near the stoichiometric air-fuel ratio.

2. The control device for the internal combustion engine according to claim 1, wherein the correction process is a process of correcting an excess air ratio calculated based on an output value of the upstream-side air-fuel ratio sensor.

3. The control device for the internal combustion engine according to claim 1, wherein the correction process is a process of making the correction by calculating a difference between the output of the upstream-side air-fuel ratio sensor and the output of the downstream-side air-fuel ratio sensor.

4. The control device for the internal combustion engine according to claim 1, wherein the control device is configured to carry out sub-air-fuel ratio control of correcting a value related to the air-fuel ratio control by using a sub-correction value calculated based on the output of the downstream-side air-fuel ratio sensor, and also execute a process of modifying the sub-correction value in a case where the correction process is executed.

5. The control device for the internal combustion engine according to claim 1, wherein the internal combustion engine is an internal combustion engine that uses hydrogen as fuel.
